(19) United States
(12) Patent Application Publication
(10) Pub. No.: US 2020/0059965 A1
(43) Pub. Date: Feb. 20, 2020

(54) METHOD FOR BEAMFORMED ACCESS IN UNLICENSED BAND USING RTS AND CTS

(71) Applicant: Nokia Technologies Oy, Espoo (FI)

(72) Inventors: Nitin Mangalvedhe, Hoffman Estates, IL (US); Jun Tan, Lake Zurich, IL (US)

(73) Assignee: Nokia Technologies Oy

(21) Appl. No.: 16/104,627

(22) Filed: Aug. 17, 2018

(51) Int. Cl. H04W 74/08; H04L 5/00; H04W 24/10

(52) U.S. Cl. CPC H04W 74/0816; H04W 24/10; H04L 5/0048

(57) ABSTRACT

A method includes determining, by an access point device, whether a channel is clear. The channel includes an unlicensed carrier. The method also includes sending an omnidirectional request-to-send transmission containing a beam identifier that the access point device will use for transmitting data; and receiving a clear-to-send message in response to the request-to-send message. In response to receiving the clear-to-send message, the method includes performing directional transmission of data using the beam identified in the request-to-send transmission.

### TECHNICAL FIELD

The teachings in accordance with the exemplary embodiments of this invention relate generally to radio standards and particularly, to beam-based transmission and reception.

### BACKGROUND

3GPP determines standards for radio technology, such as NR technology, for use in unlicensed spectrum below 7 GHz. NR technology enables beam-based transmission and reception. With current technology for the unlicensed band, a device that intends to send data to another device on the unlicensed wireless channel typically uses clear channel assessment (CCA) to ensure that the channel is clear after which it performs an omnidirectional transmission. Such a transmission is received by all devices around the transmitting device. Thus, CCA avoids causing interference to ongoing transmissions. On the other hand, another device that cannot hear the transmission may determine that the channel is clear for its own use and start another transmission that would cause interference to the receiving device. This phenomenon is the hidden node problem. The request-to-send (RTS)-clear-to-send (CTS) mechanism is designed to solve this hidden node problem. This mechanism essentially ensures that devices around both the transmitter and the receiver are informed of the transmission and hence avoid any interfering transmissions.

Certain abbreviations that may be found in the description and/or in the Figures are herewith defined as follows:
AP Access Point
BF Beamforming
CCA Clear Channel Assessment
CSI Channel State Information
CTS Clear-To-Send
DL Down link
FDM Frequency division multiplexing
LBT Listen-Before-Talk
MIMO Multiple-Input Multiple-Output
NR New radio
RTS Request-To-Send
TDM Time division multiplexing
UE User Equipment
UL Uplink
3GPP Third Generation Partnership Project
5G Fifth generation mobile communication system

### BRIEF SUMMARY

The following summary includes examples and is merely intended to be exemplary. The summary is not intended to limit the scope of the claims.

In accordance with one aspect, an example method comprises determining, by an access point device, whether a channel is clear, wherein the channel includes an unlicensed carrier; sending an omnidirectional request-to-send transmission containing a beam identifier that the access point device will use for transmitting data; receiving a clear-to-send message in response to the request-to-send message; and in response to receiving the clear-to-send message, performing directional transmission of data using the beam identified in the request-to-send transmission.

In accordance with another aspect, an example apparatus comprises means for determining whether a channel is clear, wherein the channel includes an unlicensed carrier; means for sending an omnidirectional request-to-send transmission containing a beam identifier that the apparatus will use for transmitting data; means for receiving a clear-to-send message in response to the request-to-send message; and in response to receiving the clear-to-send message, means for performing directional transmission of data using the beam identified in the request-to-send transmission.

In accordance with one aspect, an example method comprises receiving, by a user terminal device, a request-to-send transmission containing a beam identifier from at least one access point device; decoding the request-to-send transmission; determining that the apparatus is an intended recipient of the request-to-send transmission; determining that a channel is clear; and transmitting a clear-to-send message based on the beam identifier in response to the request-to-send message on a beam directed towards the at least one access point device.

In accordance with another aspect, an example apparatus comprises means for receiving a request-to-send transmission containing a beam identifier from at least one access point device; means for decoding the request-to-send transmission; means for determining that the apparatus is an intended recipient of the request-to-send transmission; means for determining that a channel is clear; and means for transmitting a clear-to-send message based on the beam identifier in response to the request-to-send message on a beam directed towards the at least one access point device.

In accordance with another aspect, an example apparatus comprises at least one processor; and at least one non-transitory memory including computer program code, the at least one memory and the computer program code may be configured to, with the at least one processor, cause the apparatus to: determine by an access point device, whether a channel is clear, wherein the channel includes an unlicensed carrier; send an omnidirectional request-to-send transmission containing a beam identifier that the access point device will use for transmitting data; receive a clear-to-send message in response to the request-to-send message; and in response to receiving the clear-to-send message, perform directional transmission of data using the beam identified in the request-to-send transmission.

In accordance with another aspect, an example apparatus comprises a non-transitory program storage device readable by a machine, tangibly embodying a program of instructions executable by the machine for performing operations, the operations comprising: determining, by an access point device, whether a channel is clear, wherein the channel includes an unlicensed carrier; sending an omnidirectional request-to-send transmission containing a beam identifier that the access point device will use for transmitting data; receiving a clear-to-send message in response to the request-to-send message; and in response to receiving the clear-to-send message, performing directional transmission of data using the beam identified in the request-to-send transmission.

In accordance with another aspect, an example apparatus comprises a non-transitory program storage device readable by a machine, tangibly embodying a program of instructions executable by the machine for performing operations, the operations comprising: receiving, by a user terminal device, a request-to-send transmission containing a beam identifier from at least one access point device; decoding the request-to-send transmission; determining that the apparatus is an intended recipient of the request-to-send transmission; determining that a channel is clear; and transmitting a clear-to-send message based on the beam identifier in response to the request-to-send message on a beam directed towards the at least one access point device.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 is a block diagram of one possible and non-limiting example system in which the example embodiments may be practiced;

FIG. 2 shows an example illustration of an RTS/CTS mechanism;

FIG. 3 shows an example illustration of a table maintained by NR-U AP;

FIG. 4 shows an example illustration of a table maintained by a UE;

FIG. 5 shows an example illustration of RTS-CTS based communication using beamforming;

FIG. 6 shows a method in accordance with example embodiments which may be performed by an apparatus; and

FIG. 7 shows a method in accordance with example embodiments which may be performed by an apparatus.

### DETAILED DESCRIPTION

In the example embodiments as described herein a method and apparatus that provides multi-beam downlink channel control procedures.

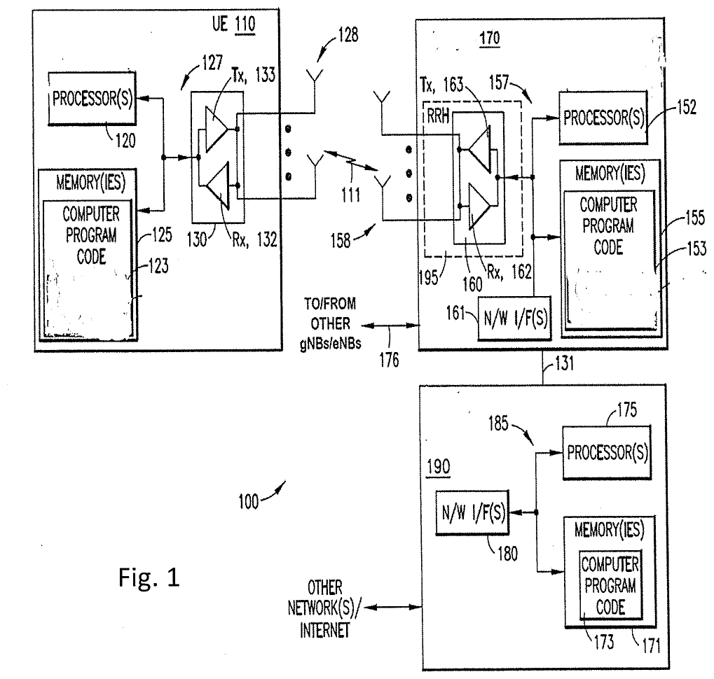

Turning to FIG. 1, this figure shows a block diagram of one possible and non-limiting example system in which the example embodiments may be practiced. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a report module 140, comprising one of or both parts 140-1 and/or 140-2, which may be implemented in a number of ways. The report module 140 may be implemented in hardware as report module 140-1, such as being implemented as part of the one or more processors 120. The report module 140-1 may be implemented also as an integrated circuit or through other hardware such as a programmable gate array. In another example, the report module 140 may be implemented as report module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with gNB 170 via a wireless link 111.

The gNB (NR/5G Node B but possibly an evolved NodeB) 170 is a base station (e.g., for LTE, long term evolution, or for NR, New Radio) that provides access by wireless devices such as the UE 110 to the wireless network 100. The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The gNB 170 includes a signaling module 150, comprising one of or both parts 150-1 and/or 150-2, which may be implemented in a number of ways. The signaling module 150 may be implemented in hardware as signaling module 150-1, such as being implemented as part of the one or more processors 152. The signaling module 150-1 may be implemented also as an integrated circuit or through other hardware such as a programmable gate array. In another example, the signaling module 150 may be implemented as signaling module 150-2, which is implemented as computer program code 153 and is executed by the one or more processors 152. For instance, the one or more memories 155 and the computer program code 153 are configured to, with the one or more processors 152, cause the gNB 170 to perform one or more of the operations as described herein. The one or more network interfaces 161 communicate over a network such as via the links 176 and 131. Two or more gNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the gNB 170 being physically in a different location from the RRH, and the one or more buses 157 could be implemented in part as fiber optic cable to connect the other elements of the gNB 170 to the RRH 195.

It is noted that description herein indicates that “cells” perform functions, but it should be clear that the gNB that forms the cell will perform the functions. The cell makes up part of a gNB. That is, there can be multiple cells per gNB. Each cell may contain one or multiple transmission and receiving points (TRPs).

The wireless network 100 may include a network control element (NCE) 190 that may include MME (Mobility Management Entity)/SGW (Serving Gateway) functionality, and which provides connectivity with a further network, such as a telephone network and/or a data communications network (e.g., the Internet). The gNB 170 is coupled via a link 131 to the NCE 190. The link 131 may be implemented as, for example, an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, gNB 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Embodiments herein may be implemented in software (executed by one or more processors), hardware (e.g., an application specific integrated circuit), or a combination of software and hardware. In an example of an embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium or other device that may be any media or means that can contain or store the instructions for use by or in connection with an instruction execution system, apparatus, or device, such as a computer.

The current architecture in LTE networks is fully distributed in the radio and fully centralized in the core network. The low latency requires bringing the content close to the radio which leads to local break out and multi-access edge computing (MEC). 5G may use edge cloud and local cloud architecture. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services and augmented reality. In radio communications, using edge cloud may mean node operations to be carried out, at least partly, in a server, host or node operationally coupled to a remote radio head or base station comprising radio parts. It is also possible that node operations will be distributed among a plurality of servers, nodes or hosts. It should also be understood that the distribution of labor between core network operations and base station operations may differ from that of the LTE or even be non-existent. Some other technology advancements probably to be used are Software-Defined Networking (SDN), Big Data, and all-IP, which may change the way networks are being constructed and managed.

Having thus introduced one suitable but non-limiting technical context for the practice of the example embodiments of this invention, the example embodiments will now be described with greater specificity.

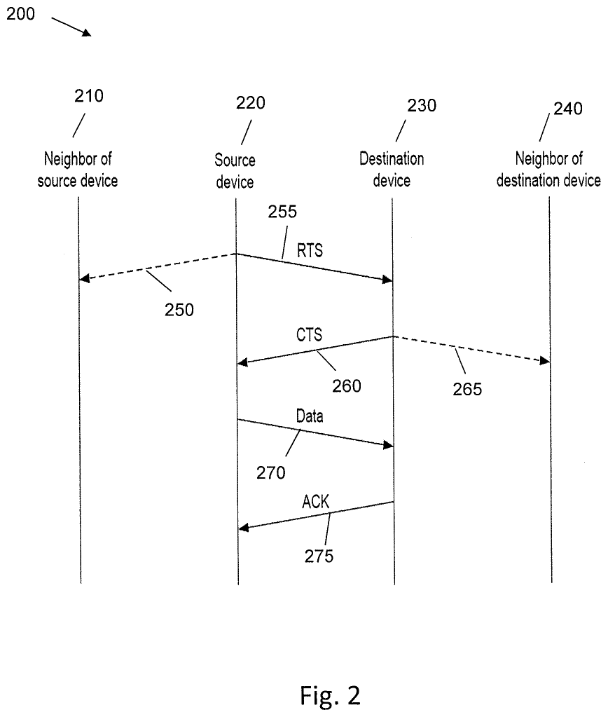

FIG. 2 illustrates an RTS/CTS mechanism. As shown in FIG. 2, the RTS/CTS mechanism may include signalling between a neighbor of a source device 210, a source device 220, a destination device 230, and a neighbor of a destination device 240.

In the CCA mechanism, a source device 220 that needs to send data to a destination device 230, uses listen-before-talk (LBT), where its senses the channel and if it is free (for example, the measured signal level is below a threshold), that the source device 220 transmits. A RTS-CTS mechanism is illustrated in FIG. 2. With this mechanism, the source device 220 performs LBT 250 for the RTS transmission 255 and the destination device 230 performs LBT 265 for the CTS transmission 260. Then neighbors of both the sending source device 220 (for example, neighbor of source device 210) and the destination device 230 (for example, neighbor of destination device 240) that receive and decode the RTS or CTS transmissions are informed of the imminent data transmission and hold off their own transmissions until the end of the data 270 and ACK communication 275. This is useful for omnidirectional transmissions because any transmissions by the neighbour devices (210, 240) could disrupt the communication between the source device 220 and destination device (node) 230.

The use of antenna beams for transmission allows for focusing the transmitted signal in the direction of the receiver while reducing signal power in other directions. Likewise, a receiver that uses beamforming may reduce interference received from directions other than that of the transmitter. Therefore, if the sending device (for example source device 220) uses beamforming, it is unlikely to cause interference to a neighbor device (for example, neighbor of source device 210) in a direction that is not within the transmit beam. Likewise, if the destination device 230 uses receiver beamforming, the destination device 230 has a low probability (for example, is unlikely to) receive interference from a neighbor device in a direction not within a receive beam of the destination device 230. This means that other transmissions may be simultaneously supported for improving spatial reuse of the channel. The mechanisms for unlicensed channel access, including the RTS-CTS mechanism as shown in FIG. 2, do not exploit these aspects to improve spatial reuse. Using beam-based transmission and reception in unlicensed radio spectrum (for example, NR-U) the example embodiments described herein provide a method to enable devices to efficiently reuse the unlicensed channel by considering directional properties of the transmitted and received antenna beams.

The example embodiments enable the spatial reuse of the wireless channel in the unlicensed band through the distribution of information on the spatial beams used for transmissions using an enhanced RTS-CTS mechanism.

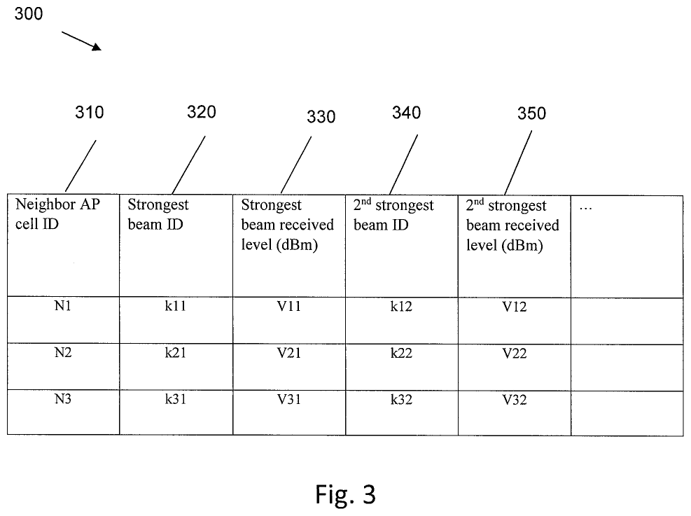

Referring to FIG. 3, there is shown an example illustration of a table 300 maintained by a NR-U AP 170. As shown in FIG. 3, table 300 includes a neighbor AP cell ID 310 (shown, by way of an example embodiment, as N1, N2 and N3), a strongest beam ID 320 (shown, by way of an example embodiment, as k11, k21 and k31), a strongest beam received level 330 (in units of dBm) (shown, by way of an example embodiment, as V11, V21 and V31), a 2^{nd} strongest beam ID 340 (shown, by way of an example embodiment, as k12, k22 and k32), a 2^{nd} strongest beam received level 350 (in units of dBm) (shown, by way of an example embodiment, as V12, V22 and V32), and may include additional information, for example, regarding additional beams. Exemplary values are represented in FIG. 3.

The enhanced RTS-CTS mechanism may include the following steps. When the NR-U access points (APs) 170 are deployed, each NR-U AP 170 may learn about its neighbouring APs 170 through a one-time beam measurement procedure and based on previously shared beam configuration information. Each NR-U AP 170 may transmit CSI-RS on all of its beams. CSI-RS transmission on different beams may be, for example, TDM or FDM. NR-U APs 170 may be used for unlicensed-band base stations (as is done for Wi-Fi), which have a much smaller transit power than base stations used for licensed band, such as eNodeBs/gNodeBs.

The reference signal configuration of each AP 170 may be shared with neighboring APs 170. The CSI-RS configuration of each AP may be shared with neighboring APs 170. When an NR-U AP 170 is transmitting beamformed reference signals, other (neighbouring) APs 170 perform measurements to determine the reference signals with a received level above a certain threshold (for example, X dBm (decibels-milliwatts), where X is a predetermined value).

After the completion of the beam sweeping and measurement process, each NR-U AP 170 maintains a table with each of whose entries as shown in FIG. 3. The entries shown in the table are labels or variables for corresponding values. This table may be referred to as the neighbor AP beam profile.

An enhanced RTS-CTS mechanism may be implemented in which the RTS contains information on the transmit beam to be used for data transmission. When an NR-U AP 170 determines that it can use the channel after CCA, the NR-U AP 170 may transmit an omnidirectional RTS on the unlicensed carrier containing the ID of the beam that the NR-U AP 170 will use for the data transmission. When the UE 110 receives and decodes the RTS and determines that it is the intended recipient, the UE 110 transmits a CTS on a beam directed towards the NR-U AP 170 if the UE 110 determines that the channel is clear. If the NR-U AP 170 receives the CTS in response to its RTS, the NR-U AP 170 performs directional transmission on the beam indicated in the RTS.

UEs 110 may periodically measure the beamformed reference signals from neighboring APs 170. Each UE 110 may perform measurements to determine the reference signals with a received level above a certain threshold (for example, Y dBm, where Y is a predetermined variable). The UE 110 may also determine the best receive beam for receiving transmissions on the strongest beam from each AP 170.

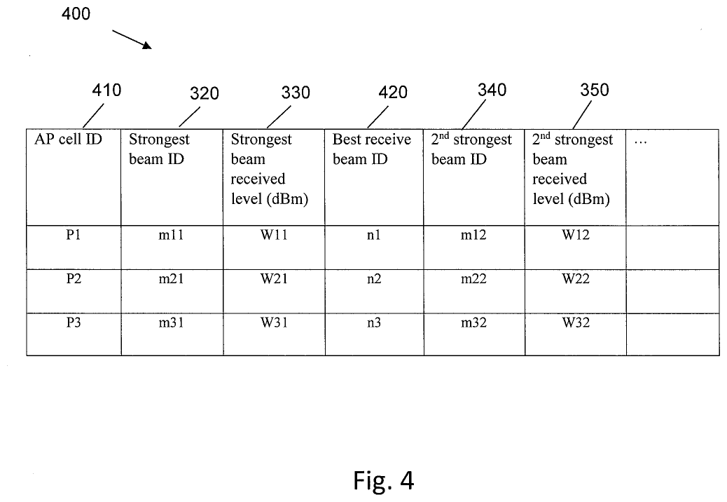

Each UE 110 may maintain a table 400 with entries such as shown by way of example in FIG. 4.

FIG. 4 is an illustration of a table 400 maintained by a UE 110 with each of whose entries. As shown in FIG. 4, table 400 may include entries for a AP cell ID 410 (shown, by way of an example embodiment, as P1, P2 and P3), a strongest beam ID 320 (shown, by way of an example embodiment, as m11, m21 and m31), a strongest beam received level 330 (in units of dBm) (shown, by way of an example embodiment, as W11, W21 and W31), a best receive beam ID 420 (shown, by way of an example embodiment, as n1, n2 and n3), a 2^{nd} strongest beam ID 340 (shown, by way of an example embodiment, as m12, m22 and m32), a 2^{nd} strongest beam received level 350 (in units of dBm) (shown, by way of an example embodiment, as W12, W22 and W32), and may include additional information, for example, regarding additional beams.

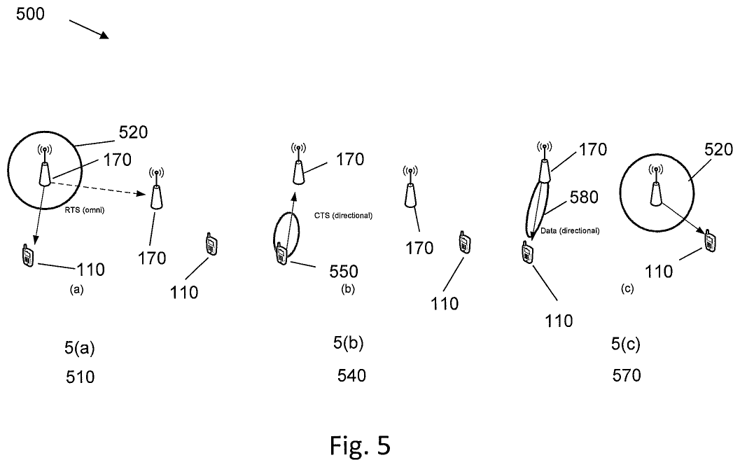

FIG. 5 provides an example illustration of RTS-CTS based communication using beamforming 500.

As shown in FIG. 5, an enhanced RTS-CTS mechanism 500 may be used in which the RTS contains information on the transmit beam to be used for data transmission. Enhanced RTS-CTS mechanism 500 is illustrated in stages 5(a) 510, 5(b) 540 and 5(c) 570.

When an NR-U AP 170 determines that it can use the channel after CCA, it transmits an omnidirectional RTS on the unlicensed carrier (5(a) 510 of FIG. 5).

The RTS transmission 520 may be scheduled through control signalling on the licensed carrier. In other instances, the RTS may be transmitted on the licensed carrier directly without any scheduling on the licensed carrier. Alternatively, the RTS transmission 520 may be scheduled though an alternate process.

For example, the RTS transmission 520 may be implemented on a channel that is defined for the RTS transmission 520 with characteristics as follows. The RTS transmission 520 may use a unique common reference signal enabling all neighbouring APs 170 and UEs 110 to quickly identify the RTS 520 and decode it. The RTS transmission 520 uses a fixed (predetermined) MCS and contains a fixed (predetermined) payload size. The RTS transmission 520 includes uniform transmission in all directions (omnidirectional).

The RTS payload may include the following: Cell ID of the NR-U AP 170. UE ID of the targeted UE 110. Beam ID that the NR-U AP 170 will use for the data transmission. Length of the data transmission.

When the UE 110 receives and decodes the RTS and it determines that it is the intended recipient, the UE 110 transmits a CTS 550 on a beam directed towards the NR-U AP 170 if the UE 110 determines that the channel is clear (5(b) 540 of FIG. 5). In this instance, transmission of CTS 550 is required by the protocol. The UE 110 may transmit the CTS 550 on the same beam that it would use to receive the data transmission.

In some example embodiments, the UE 110 may transmit a CTS 550 on an omni-directional beam. In these instances, or in certain other embodiments, the UE 110 may also receive the data transmission using an omni-directional beam.

The UE 110 may be configured (or instructed) to not transmit a CTS 550 if the channel is not clear. The AP 170 may then determine that the channel is not clear for the UE 110 and abort its data transmission.

The CTS transmission 550 may be performed on a defined channel. The RTS transmission 520 may use a common reference signal enabling all neighboring APs 170 and UEs 110 to (for example, quickly) identify the CTS 550 and decode it. The CTS transmission 550 may use a fixed (predetermined) MCS and contain a fixed (predetermined) payload size.

The CTS payload may include the following: The UE ID. The cell ID of the targeted AP. Length of the data transmission (which may be (or have been) obtained from the RTS). With AP-side beam correspondence, the NR-U AP 170 may use the same beam for CTS reception as it will use for data transmission.

If the NR-U AP 170 receives the CTS 550 in response to its RTS 520, it performs directional data transmission 580 (5(c) 570 of FIG. 5).

The AP 170 uses the beam that it indicated in the RTS payload. If the AP 170 does not receive the CTS or is unable to decode it due to collision or interference, the AP 170 may deem (determine) that the channel is not clear for the UE 110 and abort the data transmission.

The UE 110 receives the data transmission on its best receive beam. If the UE 110 is able to successfully decode the data transmission, the UE 110 may transmit an ACK to the AP 170 using the same beam that it used for CTS transmission 550. Alternatively, the ACK may be transmitted on the PUCCH of the licensed carrier.

Alternatively, if AP 170 knows UE's 110 location, or specifically, the DL beam IDs associated to a UE 110, this modified RTS/CTS mechanism may be applied. When an NR-U AP 170 determines that it can use the channel after CCA (for example, the channel is clear for communication), the NR-U AP 170 may transmit an omnidirectional RTS (omni-RTS), followed by one or multiple beamformed RTS (BF-RTS) at one or multiple downlink beams.

If the intended UE 110 can receive and decode both omni-RTS and BF-RTS with one beam, and if the UE 110 determines the channel with the desired beam is clear, the UE 110 may transmit an omni-CTS (omnidirectional CTS) and/or one beamformed CTS 550 (BF-CTS) to the AP 170, provided that the UE 110 has UL-MIMO capability. If a UE 110 can receive/decode omni-RTS and cannot detect BF-RTS, the UE 110 won't transmit CTS since the intended RTS 520 is not for this UE 110. If the NR-U AP 170 receives the CTS in response to its RTS 520, the NR-U AP 170 may perform directional transmission 580 for data channel. The NR-U AP 170 may use the beam: i) indicated in the RTS payload, or ii) indicated in the CTS 550 by the UE 110. The UE 110 may receive the DL transmission with its receive beam.

In the example embodiments, the information on the beam to be used for data transmission is signalled in the RTS transmission 520. The example embodiments enable each the NR-U AP 170 to identify the best beam(s) from neighbouring APs 170 based on prior sharing of reference signal configurations among APs 170.

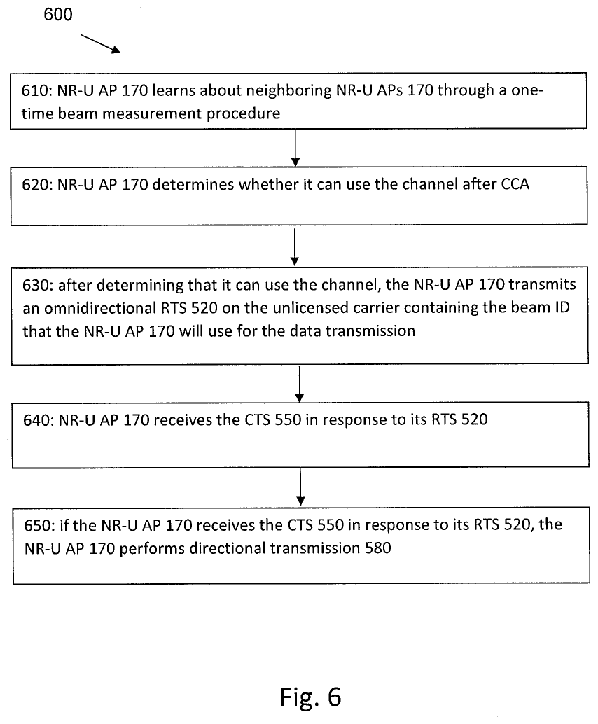

FIG. 6 is an example flow diagram 600 illustrating a method in accordance with example embodiments which may be performed by an apparatus.

At block 610, each NR-U AP 170 may learn about its neighboring NR-U APs 170 through a one-time beam measurement procedure and based on previously shared beam configuration information, for example when the NR-U APs 170 are deployed. NR-U AP 170 may determine the existence of and parameters associated with the neighboring NR-U APs 170.

At block 620, the NR-U AP 170 may determine (for example, via CCA) whether it can use a communication channel. For example, NR-U AP 170 may determine whether the medium is idle.

At block 630, after determining that it can use the channel, the NR-U AP 170 may transmit an omnidirectional RTS 520 on the unlicensed carrier containing the beam ID that the NR-U AP 170 will use for the data transmission.

At block 640, NR-U AP 170 may receive CTS 550 in response to its RTS 520.

At block 650, if the NR-U AP 170 receives the CTS 550 in response to its RTS 520, the NR-U AP 170 may perform directional transmission 580 based on the information about the at least one neighboring NR-U AP 170.

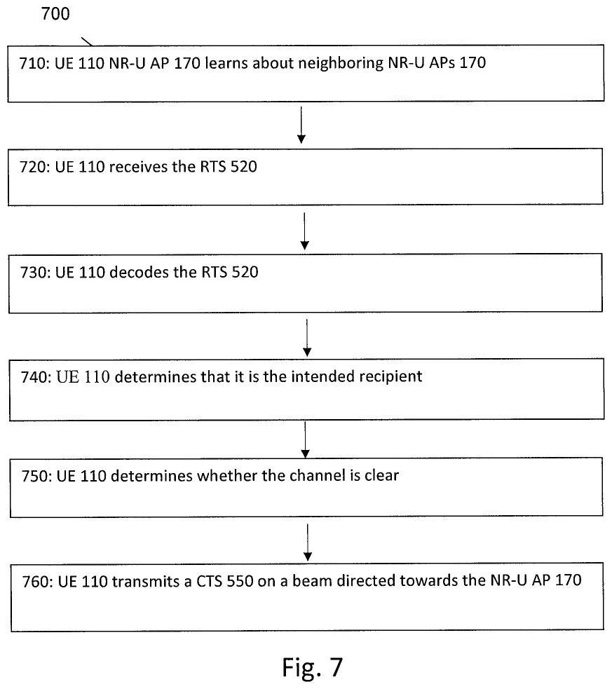

FIG. 7 is an example flow diagram 700 illustrating a method in accordance with example embodiments which may be performed by an apparatus.

At block 710, UE 110 NR-U AP 170 learns about neighboring NR-U APs 170

At block 720, UE 110 may receive the RTS 520 from an NR-U AP 170.

At block 730, the UE 110 may decode the RTS 520.

At block 740, the UE 110 may determine whether it is the intended recipient of the CTS 520 from the NR-U AP 170.

At block 760, the UE 110 may determine whether a channel is clear.

At block 760, the UE 110 may transmit a CTS 550 on a beam directed towards the NR-U AP 170 if it determines that the channel is clear.

Without in any way limiting the scope, interpretation, or application of the claims appearing below, a technical effect of one or more of the example embodiments disclosed herein is that RTS informs neighboring APs and UEs which beam will be used for the downlink data transmission. These neighboring APs and UEs would then know of potential interference from this data transmission. Based on this knowledge, APs may initiate spatially separated transmissions to other UEs.

An example embodiment may provide a method comprising determining, by an access point device, whether a channel is clear, wherein the channel includes an unlicensed carrier; sending an omnidirectional request-to-send transmission containing a beam identifier that the access point device will use for transmitting data; receiving a clear-to-send message in response to the request-to-send message; and in response to receiving the clear-to-send message, performing directional transmission of data using the beam identified in the request-to-send transmission.

In accordance with the example embodiments as described in the paragraphs above, learning information about at least one neighboring access point device through a beam measurement procedure; and using the information about the at least one neighboring access point device to determine whether the access point device can engage in simultaneous transmission with the at least one neighboring access point device without causing mutual interference between transmissions from the access point device and the at least one neighboring access point device.

In accordance with the example embodiments as described in the paragraphs above, wherein learning the information about the at least one neighboring access point device further comprises learning the information about the at least one neighboring access point device based on previously shared beam configuration information.

In accordance with the example embodiments as described in the paragraphs above, wherein the information includes a reference signal configuration of each of the at least one neighboring access point device.

In accordance with the example embodiments as described in the paragraphs above, wherein learning the information about the at least one neighboring access point device further comprises identifying that at least one neighboring access point device is transmitting at least one beamformed reference signal; and performing at least one measurements to determine at least one of the at least one beamformed reference signal with a received level above a predetermined threshold.

In accordance with the example embodiments as described in the paragraphs above, wherein determining whether the channel is clear further comprises determining whether the channel is clear using clear channel assessment.

In accordance with the example embodiments as described in the paragraphs above, wherein transmitting the omnidirectional request-to-send message further comprises scheduled the omnidirectional request-to-send message through control signalling on at least one licensed carrier.

In accordance with the example embodiments as described in the paragraphs above, wherein the omnidirectional request-to-send transmission uses a common reference signal.

In accordance with the example embodiments as described in the paragraphs above, wherein the access point device uses a same beam for reception as used for transmission.

In accordance with the example embodiments as described in the paragraphs above, wherein the omnidirectional request-to-send transmission further includes at least one of a cell identifier of the access point device, a user terminal identifier of a targeted user terminal, and a length of a data transmission.

An example embodiment may be provided in an apparatus comprising at least one processor; and at least one non-transitory memory including computer program code, the at least one memory and the computer program code may be configured to, with the at least one processor, cause the apparatus to: determine whether a channel is clear, wherein the channel includes an unlicensed carrier; send an omnidirectional request-to-send transmission containing a beam identifier that the apparatus will use for transmitting data; receive a clear-to-send message in response to the request-to-send message; and in response to receiving the clear-to-send message, perform directional transmission of data using the beam identified in the request-to-send transmission.

In accordance with the example embodiments as described in the paragraphs above, learn information about at least one neighboring access point device through a beam measurement procedure; and use the information about the at least one neighboring access point device to determine whether the apparatus can engage in simultaneous transmission with the at least one neighboring access point device without causing mutual interference between transmissions from the access point device and the at least one neighboring access point device.

In accordance with the example embodiments as described in the paragraphs above, learn the information about the at least one neighboring access point device based on previously shared beam configuration information.

In accordance with the example embodiments as described in the paragraphs above, maintain a table of the information about each of the at least one neighboring access point device including at least a neighbor cell identifier, a strongest beam identifier, a strongest beam received level, a second strongest beam identifier, and a second strongest beam received level.

In accordance with the example embodiments as described in the paragraphs above, determine whether the channel is clear using clear channel assessment.

An example embodiment may be provided in an apparatus comprising means for determining whether a channel is clear, wherein the channel includes an unlicensed carrier; means for sending an omnidirectional request-to-send transmission containing a beam identifier that the apparatus will use for transmitting data; means for receiving a clear-to-send message in response to the request-to-send message; and in response to receiving the clear-to-send message, means for performing directional transmission of data using the beam identified in the request-to-send transmission.

In accordance with the example embodiments as described in the paragraphs above, means for learning information about at least one neighboring access point device through a beam measurement procedure; and means for using the information about the at least one neighboring access point device to determine whether the access point device can engage in simultaneous transmission with the at least one neighboring access point device without causing mutual interference between transmissions from the access point device and the at least one neighboring access point device.

In accordance with the example embodiments as described in the paragraphs above, wherein, when learning the information about the at least one neighboring access point device, the apparatus further comprises: means for learning the information about the at least one neighboring access point device based on previously shared beam configuration information.

In accordance with the example embodiments as described in the paragraphs above, means for maintaining a table of the information about each of the at least one neighboring access point device including at least a neighbor cell identifier, a strongest beam identifier, a strongest beam received level, a second strongest beam identifier, and a second strongest beam received level.

In accordance with the example embodiments as described in the paragraphs above, means for determining whether the channel is clear using clear channel assessment.

An example embodiment may provide a method comprising receiving, by a user terminal device, a request-to-send transmission containing a beam identifier from at least one access point device; decoding the request-to-send transmission; determining that the apparatus is an intended recipient of the request-to-send transmission; determining that a channel is clear; and transmitting a clear-to-send message based on the beam identifier in response to the request-to-send message on a beam determined by the user terminal device.

In accordance with the example embodiments as described in the paragraphs above, wherein the request-to-send transmission further includes at least one of a cell identifier of the at least one access point device, a user terminal identifier of the user terminal device, and a length of a data transmission.

In accordance with the example embodiments as described in the paragraphs above, receiving directional transmission of data using the beam identified in the request-to-send transmission.

In accordance with the example embodiments as described in the paragraphs above, determining the beam based on at least one measurement by the user terminal device, wherein the at least one measurement includes at least one beamformed reference signals from at least one neighboring access point; and determining whether a reference signal includes a received level above a certain threshold.

An example embodiment may be provided in an apparatus comprising means for receiving a request-to-send transmission containing a beam identifier from at least one access point device; means for decoding the request-to-send transmission; means for determining that the apparatus is an intended recipient of the request-to-send transmission; means for determining that a channel is clear; and means for transmitting a clear-to-send message based on the beam identifier in response to the request-to-send message on a beam determined by the apparatus.

In accordance with the example embodiments as described in the paragraphs above, wherein the beam determined by the user terminal device further comprises a beam directed towards the at least one access point device.

An example embodiment may be provided in an apparatus comprising at least one processor; and at least one non-transitory memory including computer program code, the at least one memory and the computer program code may be configured to, with the at least one processor, cause the apparatus to: receive, by a user terminal device, a request-to-send transmission containing a beam identifier from at least one access point device; decode the request-to-send transmission; determine that the apparatus is an intended recipient of the request-to-send transmission; determine that a channel is clear; and transmit a clear-to-send message based on the beam identifier in response to the request-to-send message on a beam directed towards the at least one access point device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments, these descriptions should not be viewed in a limiting sense. Rather, there are several variations and modifications which may be made without departing from the scope of the present invention.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications which may be made without departing from the scope of the present invention as defined in the appended claims.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope ofthe invention which is defined by the claims.

The foregoing description has provided by way of example and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. A method, comprising:
determining, by an access point device, whether a channel is clear, wherein the channel includes an unlicensed carrier;
sending an omnidirectional request-to-send transmission containing a beam identifier that the access point device will use for transmitting data;
receiving a clear-to-send message in response to the request-to-send message; and
in response to receiving the clear-to-send message, performing directional transmission of data using the beam identified in the request-to-send transmission.

2. The method of claim 1, further comprising:
learning information about at least one neighboring access point device through a beam measurement procedure; and
using the information about the at least one neighboring access point device and the beam identifier information in a request-to-send transmission from the at least one neighboring access point device to determine whether the access point device can engage in simultaneous transmission with a user terminal device without causing mutual interference between transmissions from the access point device and the at least one neighboring access point device.

3. The method according to claim 2, wherein learning the information about the at least one neighboring access point device further comprises:
learning the information about the at least one neighboring access point device based on previously shared beam configuration information.

4. The method according to claim 2, wherein the information includes a reference signal configuration of each of the at least one neighboring access point device.

5. The method according to claim 2, wherein learning the information about the at least one neighboring access point device further comprises:
identifying that at least one neighboring access point device is transmitting at least one beamformed reference signal; and
performing at least one measurement to determine at least one of the at least one beamformed reference signal with a received level above a predetermined threshold.

6. The method according to claim 2, further comprising:
maintaining a table of the information about each of the at least one neighboring access point device including at least a neighbor cell identifier, a strongest beam identifier, a strongest beam received level, a second strongest beam identifier, and a second strongest beam received level.

7. The method according to claim 1, wherein determining whether the channel is clear further comprises:
determining whether the channel is clear using clear channel assessment.

8. The method according to claim 1, wherein the omnidirectional request-to-send transmission uses a common reference signal.

9. The method according to claim 1, wherein the access point device uses a same beam for reception as used for transmission.

10. The method according to claim 1, wherein the omnidirectional request-to-send transmission further includes at least one of a cell identifier of the access point device, a user terminal identifier of a targeted user terminal, and a length of a data transmission.

11. An apparatus, comprising:
at least one processor; and
at least one non-transitory memory including computer program code, the at least one non-transitory memory and the computer program code configured to, with the at least one processor, cause the apparatus to perform at least the following:
determine whether a channel is clear, wherein the channel includes an unlicensed carrier;
send an omnidirectional request-to-send transmission containing a beam identifier that the apparatus will use for transmitting data;
receive a clear-to-send message in response to the request-to-send message; and
in response to receiving the clear-to-send message, perform directional transmission of data using the beam identified in the request-to-send transmission.

12. The apparatus of claim 11, wherein the at least one non-transitory memory and computer program instructions are further configured to, with the at least one processor, cause the apparatus at least to:
learn information about at least one neighboring access point device through a beam measurement procedure; and
use the information about the at least one neighboring access point device to determine whether the access point device can engage in simultaneous transmission with the at least one neighboring access point device without causing mutual interference between transmissions from the access point device and the at least one neighboring access point device.

13. The apparatus according to any of claims 11 to 12, wherein, when learning the information about the at least one neighboring access point device, the at least one non-transitory memory and computer program instructions are further configured to, with the at least one processor, cause the apparatus at least to:
learn the information about the at least one neighboring access point device based on previously shared beam configuration information.

14. The apparatus according to any of claims 11 to 13, wherein the at least one non-transitory memory and computer program instructions are further configured to, with the at least one processor, cause the apparatus at least to:
maintain a table of the information about each of the at least one neighboring access point device including at least a neighbor cell identifier, a strongest beam identifier, a strongest beam received level, a second strongest beam identifier, and a second strongest beam received level.

15. A method, comprising:
receiving, by a user terminal device, a request-to-send transmission containing a beam identifier from at least one access point device;
decoding the request-to-send transmission;
determining that the apparatus is an intended recipient of the request-to-send transmission;
determining that a channel is clear; and
transmitting a clear-to-send message in response to the request-to-send message on a beam determined by the user terminal device.

16. The method of claim 15, wherein the request-to-send transmission further includes at least one of a cell identifier of the at least one access point device, a user terminal identifier of the user terminal device, and a length of a data transmission.

17. The method of claim 15, further comprising:
receiving directional transmission of data using the beam identified in the request-to-send transmission.

18. The method of claim 15, wherein the beam determined by the user terminal device further comprises:
a beam directed towards the at least one access point device.

19. The method of claim 15, further comprising:
determining the beam based on at least one measurement by the user terminal device, wherein the at least one measurement includes at least one beamformed reference signals from at least one neighboring access point; and
determining whether a reference signal includes a received level above a certain threshold.

20. An apparatus, comprising:
at least one processor; and
at least one non-transitory memory including computer program code, the at least one memory and the computer program code configured to, with the at least one processor, cause the apparatus to perform at least the following:
receive a request-to-send transmission containing a beam identifier from at least one access point device;
decode the request-to-send transmission;
determine that the apparatus is an intended recipient of the request-to-send transmission;
determine that a channel is clear; and
transmit a clear-to-send message based on the beam identifier in response to the request-to-send message on a beam determined by the apparatus.
